(19) United States
(12) Patent Application Publication
(10) Pub. No.: US 2023/0153796 A1
(43) Pub. Date: May 18, 2023

(54) CONTROLLED ENVIRONMENT FACILITY MAINTAINED DIGITAL WALLETS FOR RESIDENTS OF CONTROLLED ENVIRONMENT FACILITIES

(71) Applicant: Securus Technologies, Inc., Carrollton, TX (US)

(72) Inventors: Joseph Higgs, Fort Worth, TX (US); Adam Christopher Edwards, Fort Worth, TX (US)

(73) Assignee: Securus Technologies, Inc., Carrollton, TX (US)

(21) Appl. No.: 16/701,392

(22) Filed: Dec. 3, 2019

(51) Int. Cl. G06Q 20/36; G06Q 50/26

(52) U.S. Cl. CPC G06Q 20/3672; G06Q 20/363; G06Q 20/3674; G06Q 50/26

(57) ABSTRACT

Controlled environment facility maintained digital wallets for residents of controlled environment facilities may be created and maintained in accordance with rules and regulations of the respective controlled-environment facility. Entry of data associated with an account outside the controlled-environment facility may be received from the respective resident and inserted in the digital wallet associated with the resident as a funding source. Resident controlled-environment facility trust, communications, commissary, media, or other account(s), associated with the resident, may be created in, or assigned to, the resident’s digital wallet. Th(is)(ese) account(s) may be funded using the outside account data in the resident’s digital wallet. Payments for provision of goods or services to the resident, within and in accordance with rules and regulations of the facility, may be made from the resident’s digital wallet by automatically debiting payments from (an) appropriate resident account(s) in the resident’s digital wallet.

### TECHNICAL FIELD

This specification relates generally to controlled-environment facilities, and, more particularly, to the creation and/or management of digital wallets for residents of controlled environment facilities, under constraints imposed on the residents (inmates) of the controlled-environment facility (correctional facility).

### BACKGROUND

According to the International Centre for Prison Studies, the United States has the highest prison population per capita in the world. In 2009, for example, 1 out of every 135 U.S. residents was incarcerated. Generally, inmates convicted of felony offenses serve long sentences in prison (e.g., federal or state prisons), whereas those convicted of misdemeanors receive shorter sentences to be served in jail (e.g., county jail). In either case, while awaiting trial, a suspect or accused may remain incarcerated.

As part of its day-to-day operations, various state and federal law enforcement entities may arrest suspected criminals as well as other types of alleged offenders (e.g., parole violators, fugitives, etc.). After being taken into custody, the arrestee or detainee is typically transported to a controlled environment facility such as a holding cell, a jail, or a prison.

At the controlled environment facility, the arrestee or detainee may be subject to procedures that may depend upon the outstanding charges, arrest warrants, local regulations, etc. Generally speaking, however, the arrestee or detainee is usually stripped of his or her personal possessions (e.g., cash, watches, jewelry, clothes, personal electronics, etc.) immediately upon his or her arrival at the controlled environment facility or soon thereafter. The arrestee or detainee’s property, including the detainee’s wallet, etc. and any debit and/or credit cards therein, is typically held in a warehouse, closet, locker, or the like. However, the currency is held (i.e. deposited) in a “trust” or “trust account” until his or her release, or until its funds are depleted.

In many situations, the arrestee or detainee’s trust account is not created and/or made available to the arrestee or detainee for many hours (or even days) after the arrest. Also, such trust accounts are often limited to the amount of money (cash) that the arrestee or detainee had in his or her possession at the time of the arrest, which further limits its practical utility. In addition, monies placed in these trust accounts may sometimes be garnished to fulfill the arrestee or detainee’s other obligations (e.g., past child support, overdue restitution, probation fees, etc.).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to systems and methods which provide controlled-environment facility maintained controlled-environment facility resident digital wallets. Therein, a controlled-environment facility account management controller, and/or the like, may implement rules and regulations of a controlled-environment facility in creating a digital wallet associated with a resident of the controlled-environment facility. The controlled-environment facility account management controller, and/or the like, may, in accordance with the implementation of the rules and regulations of the controlled-environment facility, create the digital wallet associated with the resident upon intake of the resident into the controlled-environment facility, or later. Regardless, to do so, the controlled-environment facility account management controller, and/or the like, may receive data associated with an account outside the controlled-environment facility, entered by the resident in accordance with the implementation of the rules and regulations of the controlled-environment facility. This entry of data associated with an account outside the controlled-environment facility may be received by the controlled-environment facility account management controller, and/or the like, as a result of the resident swiping, or presenting for image capture, a credit or debit card and/or entering data associated with the credit or debit card, or the like, on a keypad provided by a controlled-environment facility kiosk, tablet device or terminal. The outside account may be a credit card account, a debit card account, a gift card, a checking account, a savings account, an investment account, a retirement account, a health savings account, and/or the like.

The controlled-environment facility account management controller, and/or the like, may then insert the outside account data in the digital wallet associated with the resident, as a funding source, under the rules and regulations of the controlled-environment facility. Additionally, the controlled-environment facility account management controller, and/or the like, may create or assign, in accordance with the implementation of the rules and regulations of the controlled-environment facility, a resident trust account, a resident communications account, a resident commissary account, a resident media account, and/or the like, associated with the resident, in the digital wallet associated with the resident. The controlled-environment facility account management controller, and/or the like, may then fund at least one of these resident accounts, or the like, in accordance with the implementation of the rules and regulations of the controlled-environment facility, from the outside account, using the outside account data in the digital wallet associated with the resident

Thereafter, the controlled-environment facility account management controller, and/or the like, may make payments for goods or services provided to the resident in accordance with the implementation of the rules and regulations of the controlled-environment facility, from the digital wallet associated with the resident by automatically debiting payments from (an) appropriate one(s) of the resident account(s) in the digital wallet associated with the resident. To wit, implementations of the present systems and methods may determine whether, in accordance with the rules and regulations of the controlled-environment facility, a particular good or service is allowed to be provided to the resident, provide the particular good or service to the resident and make the payment for provision of the particular good or service from the digital wallet associated with the resident, in response to a determination that in accordance with the implementation of rules and regulations of the controlled-environment facility, the particular good or service is allowed to be provided to the resident.

In accordance with some implementations of the present systems and methods, the controlled-environment facility account management controller, and/or the like, may, in accordance with the implementation of the rules and regulations of the controlled-environment facility, receive entry of data associated with, or create in, or assign to, the digital wallet associated with the resident, at least one other outside account. In accordance with such implementations, the other account(s) outside the controlled-environment facility in the digital wallet associated with the resident may be funded from the outside account using the outside account data in the digital wallet associated with the resident. Alternatively, or additionally, payments for provision of goods or services to the resident within the controlled-environment facility, may be made from the digital wallet associated with the resident by automatically debiting payments from an appropriate one(s) of the other account(s) outside the controlled-environment facility, the resident trust account, the resident communications account, the resident commissary account, the resident media account, or the like, in the digital wallet associated with the resident.

In accordance with some implementations of the present systems and methods, the controlled-environment facility account management controller, and/or the like, may, at some point, determine, in accordance with the implementation of the rules and regulations of the controlled-environment facility, whether a controlled-environment facility service provider should be allowed to issue a debit card to the resident. The controlled-environment facility account management controller, and/or the like may provide access to the digital wallet associated with the resident, in accordance with the implementation of the rules and regulations of the controlled-environment facility, via such an issued debit card. To wit, the controlled-environment facility account management controller, and/or the like, may, similar to above, determine whether, in accordance with the implementation of the rules and regulations of the controlled-environment facility, whether a particular good or service the resident is purchasing with the debit card is allowed to be provided to the resident within the controlled-environment facility. The particular good or service may be provided to the resident, and the controlled-environment facility account management controller, and/or the like may make the payment for provision of the particular good or service from the digital wallet associated with the resident, in response to a determination that in accordance with the implementation of the rules and regulations of the controlled-environment facility, the particular good or service is allowed to be provided to the resident. This may be accomplished by the controlled-environment facility account management controller, and/or the like, automatically debiting payments from (an) appropriate one(s) of the resident accounts in the digital wallet associated with the resident. Further, in accordance with such implementations of the present systems and methods, the controlled-environment facility account management controller, and/or the like, may following release of the resident from the controlled-environment facility, cease implementation of the rules and regulations of a controlled-environment facility and make payment for goods or services purchased by the resident using the debit card, irrespective of rules and regulations of the controlled-environment facility.

In accordance with various implementations of the present systems and methods, an investigative data aggregation and analysis system, and/or the like, may capture the data associated with the account outside of the controlled-environment facility and/or the provision of goods or services to the resident within the controlled-environment facility. The investigative data aggregation and analysis system, and/or the like, may analyze captured data associated with the account outside of the controlled-environment facility and/or the provision of goods or services to the resident within the controlled-environment facility for an event of investigative interest, in accordance with such implementations.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor(s), wherein the memory is configured to store program instructions executable by the processor(s) to cause the system(s) to execute one or more operations disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an illustrative environment where various systems and methods described herein may be implemented, according to some embodiments;

FIG. 2 is a block diagram of an account management controller, according to some embodiments;

FIG. 3 is a flowchart of an example implementation for providing residents of a controlled-environment facility with controlled-environment facility maintained digital wallets, according to some embodiments; and

FIG. 4 is a block diagram of a computer system, device, station, or terminal configured to implement various techniques disclosed herein, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the scope of the claims. Also, any headings used herein are for organizational purposes only and are not intended to limit the scope of the description. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For example, various types of controlled-environment facilities are present in today’s society, and persons may be voluntary or involuntary residents of such facilities, whether temporarily or permanently. Examples of controlled-environment facilities may include correctional facilities (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, barracks, etc.), and the like. For convenience of explanation, various examples discussed herein are presented in the context of correctional facilities, or the like. For instance, in some of the embodiments discussed below, a controlled-environment facility may be referred to as a correctional facility, jail or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etc.).

Embodiments of the present systems and methods relate generally to controlled-environment facilities, and, more particularly, to the creation and/or management of digital wallets for residents of controlled environment facilities, under constraints imposed on the residents (inmates) of the controlled-environment facility (correctional facility). In accordance with embodiments of the present systems and methods, controlled environment facility maintained digital wallets for residents of controlled environment facilities may be created and maintained in accordance with rules and regulations of the respective controlled-environment facility, such as by a controlled-environment facility account management controller, and/or the like. Entry of data associated with an account outside the controlled-environment facility may be received from the respective resident and inserted in the digital wallet associated with the resident as a funding source. Resident controlled-environment facility trust, communications, commissary, media, or other account(s), associated with the resident, may be created in, or assigned to, the resident’s digital wallet. Th(is)(ese) account(s) may be funded using the outside account data in the resident’s digital wallet. Payments for provision of goods or services to the resident, within and in accordance with rules and regulations of the facility, may be made from the resident’s digital wallet by automatically debiting payments from (an) appropriate resident account(s) in the resident’s digital wallet.

As used herein, the term “controlled-environment facility account” may include any financial, or similar, account created and/or maintained for the benefit of a resident of a controlled environment facility, such as, for example, trust accounts, calling accounts, commissary accounts, media accounts, controlled-environment facility vendor subscriptions, etc., as discussed below. In some of the embodiments described herein, a method may include identifying a resident committed to a controlled environment facility. The method may also include creating a trust account for the resident, where the trust account may, as noted, be a commissary account, calling account, media account, controlled-environment facility vendor subscriptions, or the like, associated with the resident. The method may further include causing funds to be deposited in the trust account, wherein the funds are accessible to the resident. In the various implementations herein, one or more of these operations may be performed with one or more computer systems to integrate the controlled-environment facility accounts and funding sources into a controlled-environment facility resident digital wallet, in accordance with embodiments of the present systems and methods.

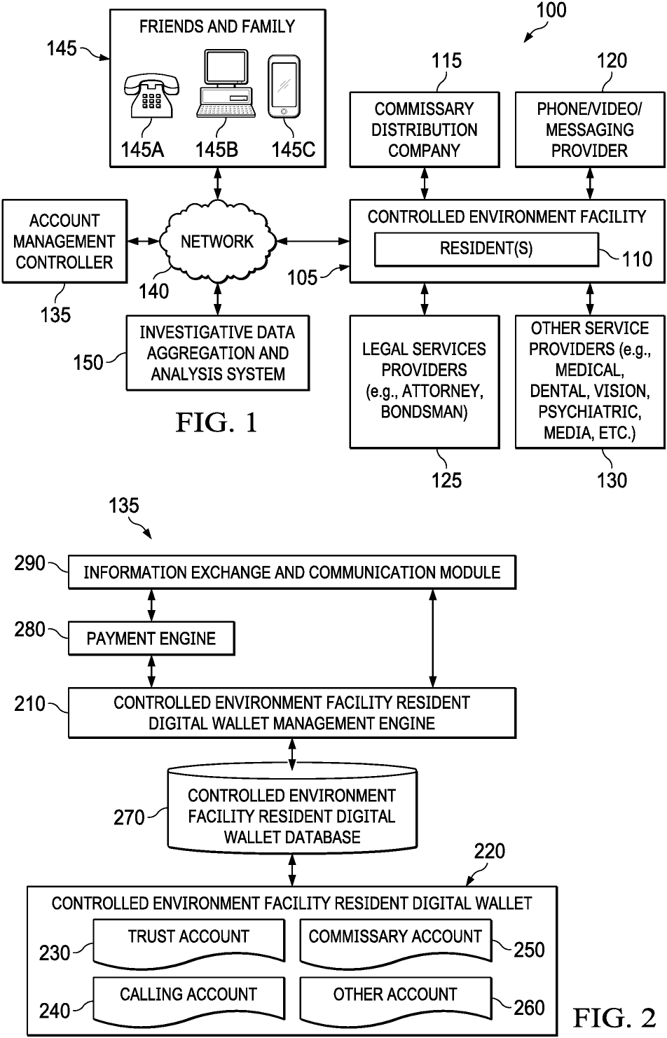

Turning to FIG. 1, a block diagram of illustrative environment 100 where various techniques described herein may be implemented, in accordance with rules and regulations of controlled-environment facility 105, is depicted according to some embodiments. As shown, controlled environment facility 105 may house one or more residents 110, in accordance with rules and regulations of controlled-environment facility 105, and residents 110 may have a desire or a need to access certain services offered to him or her while within facility 105. Some of these services may include, but are not limited to, the purchase or commissary items from commissary distribution company 115, visitation and/or communication with nonresidents through phone/video/messaging provider 120, legal services from legal service providers 125 (e.g., the services of an attorney, bail bondsman, etc.), medical, vision, dental, and psychiatric services from other providers 130, controlled-environment facility vendor subscriptions to media, and/or the like.

However, in the typical law enforcement environment, correctional facility, or the like, for example, an arrestee or detainee, upon becoming an existing resident 110 (inmate), may have his or her property held in a “trust” or “trust account.” Such a trust account may be created following procedures that are local to facility 105 (e.g., “booking”), and that in many cases may take several hours or even days to complete. Even after the trust account becomes available to existing resident 110, it may have limited practical use. For example, the amount of money placed in the trust account may be insufficient to allow the resident to conduct transactions with providers 115-130 (e.g., it may only include cash possessed at the time of the arrest). In addition, the trust account may be subject to garnishment for the fulfillment of the resident’s existing obligations (e.g., past child support, overdue restitution, probation fees, etc.).

After his or her initial processing is concluded, resident 110 may have the opportunity to open a commissary account that is specific for transactions with commissary distribution company 115 and/or a calling account (e.g., pre-paid or debit) that is specific for use with phone/video/messaging provider 120. However, similarly to the trust account, controlled-environment facility vendor subscriptions, or the like, the commissary and calling accounts may only be available to resident 110 many hours or days after his or her arrival at facility 105. In other words, resident 110 ordinarily has to wait a long period of time before he or she can conduct transactions with providers 115-130. Thus, even services that could potentially expedite the resident’s release from facility 105 (e.g., those provided by legal service providers 125) may be inaccessible to resident 110 until one or more of these various accounts is finally made available to him or her and funded, such as by a friend or family member.

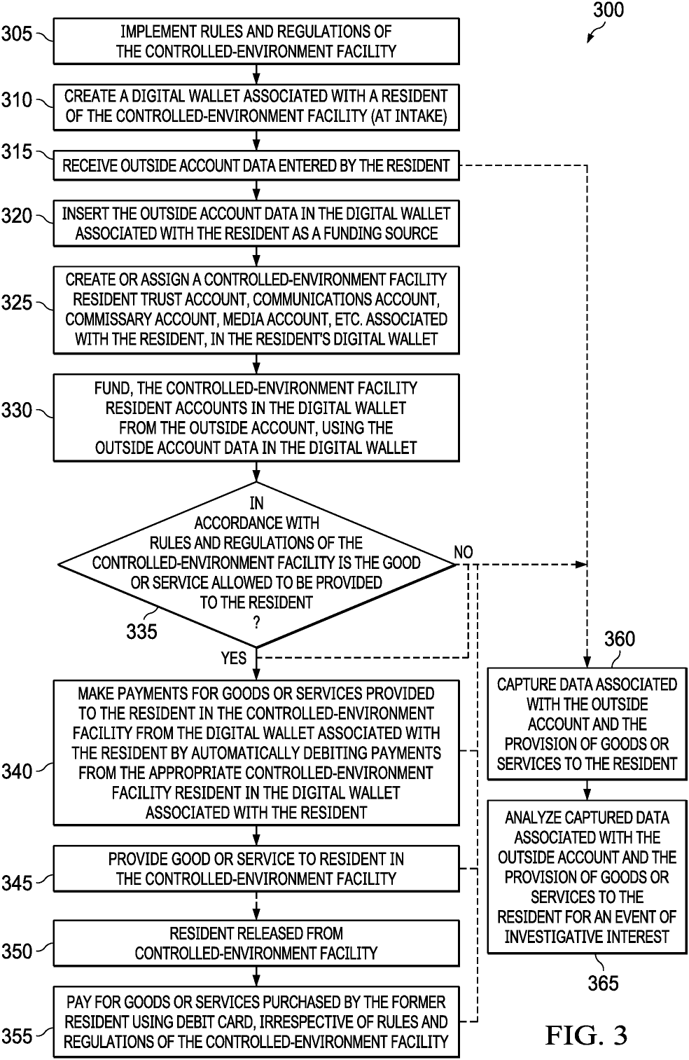

Accordingly, in some embodiments, controlled environment facility 105 may provide an indication of a resident’s (inmate’s) arrival to controlled-environment facility (correctional facility) account management controller 135 via network 140. For example, upon arrival at controlled environment facility 105, an officer or employee may enter the resident’s identification information (e.g., driver’s license number, social security number, inmate number, etc.) into the facility’s computer system, which may then automatically send a message to account management controller 135 flagging or indicating the resident’s arrival. As such, immediately or soon after the resident’s arrival at facility 105, account management controller 135 may activate, create, and/or fund a controlled-environment facility resident digital wallet associated with the resident, such as in the manner described below with respect to the implementation shown in FIG. 3. For example, account management controller 135 may create a controlled-environment facility maintained digital wallet associated with the resident of the controlled-environment facility, and in accordance with implementation of controlled-environment facility rules and/or regulations, the controlled-environment facility account management controller, or the like, receives entry of data associated with an account outside the controlled-environment facility from the resident and places/inserts the outside account data in the digital wallet associated with the resident, as a funding source. The data associated with an account outside the controlled-environment facility may be entered by, and thereby received from, the resident by the resident swiping, or otherwise presenting (e.g., inserting, or presenting for picture/image capture of) a credit card, debit card, or the like, and/or the resident entering data associated with the credit or debit card (e.g., a PIN, credit or debit card account number, and/or security code), on a keypad provided by a controlled-environment facility kiosk, tablet device, terminal, or the like. In some cases, the activation, creation, and/or funding of the controlled-environment facility resident digital wallet may occur prior to a trust account (or other accounts) being made individually accessible to resident 110. In this manner, account management controller 135 may enable resident 110 to conduct certain transactions with, and access services provided by, one or more of providers 115-130 independently of individual controlled-environment facility accounts being created for the resident. For example, commissary distribution company 115 may make collections of items available as “care packages” (e.g., starter kits with a toothbrush, toothpaste, soap, snacks, etc., holiday baskets, or the like), and may charge residents 110 for those care packages through their controlled-environment facility resident digital wallets managed by account management controller 135.

In some situations, resident 110 may directly sign up or subscribe for controlled-environment facility resident digital wallet services with account management controller 135 in anticipation of becoming a resident of facility 105 (e.g., due to knowledge of an impending criminal investigation, outstanding arrest warrant, etc.). In those cases, upon the resident’s arrival at facility 105, account management controller 135 may simply activate the resident’s account, which may have been funded in advance. In other cases, controlled environment facility 105 may have an agreement with account management controller 135 to set up controlled-environment facility resident digital wallets to all or a selected group of incoming residents.

In some embodiments, upon creation of a resident’s controlled-environment facility resident digital wallet or some time thereafter, the resident’s friends or family members 145 (or any other third party) may also fund the account. For example, a third party may call a phone number used by the entity controlling account management controller 135 and interact with a live or automated operator to request that the account be funded and to provide funding information using landline phone 145A. As another example, the third party may log into an Internet portal, website, webpage, application program (app), or the like operated by account management controller 135 and provide information sufficient to allow account management controller 135 to deposit or transfer money into the resident’s controlled-environment facility resident digital wallet using desktop computer 145B. As yet another example, the third party may transmit a text message, short message service (SMS) message, e-mail, or the like to account management controller 135 using computer 145B or smart phone 145C, or the like, via an app, website, or the like.

Additionally, or alternatively, account management controller 135 may proactively contact a third party to request or otherwise suggest that funds be deposited in the resident’s controlled-environment facility resident digital wallet. In some cases, in order to identify the resident’s friends and/or relatives, account management controller 135 may consult a database of previous residents (e.g., previously incarcerated inmates), friends and family databases, Internet databases, or the like. In other cases, account management controller 135 may receive contact information of friends or family members 145 from controlled environment facility 105. Once contact information has been obtained, account management controller 135 may place a phone call or send a text message, mobile message, e-mail, or the like informing the third party that the resident’s controlled-environment facility resident digital wallet requires funding. In some cases, an automated telephone call made through an interactive voice response (IVR) system may allow the third party to receive and provide account information. Accordingly, the third party may provide checking account, credit or debit card information, or the like to allow account management controller 135 to transfer money into the resident’s controlled-environment facility resident digital wallet.

In some cases, the activation or creation of the resident’s controlled-environment facility resident digital wallet may occur prior to or immediately after the resident’s commitment to controlled environment facility 105. As such, controlled-environment facility resident digital wallet creation and funding operations may allow resident 110 to access funds that may secure his or her release from facility 105 (e.g., in the case of legal services providers 125) more quickly or otherwise improve the conditions of his or her initial stay.

Once a controlled-environment facility resident digital wallet has been created and properly funded, providers 115-130 may conduct transactions with residents 110. In some embodiments, a provider (e.g., commissary distribution company 115) may charge a resident’s controlled-environment facility resident digital wallet through the controlled environment facility’s computer systems. Moreover, account management controller 135 may be configured to receive a transaction request from one or more of providers 115-130, and may appropriately charge the resident’s controlled-environment facility resident digital wallet for the cost of the transaction. For example, payments are made by controlled-environment facility account management controller 135, or the like, in accordance with the implementation of the controlled-environment facility rules and/or regulations, for goods, services, controlled-environment facility vendor subscriptions, or the like, provided to the resident within the controlled-environment facility, such as in response to a determination that, in accordance with rules and regulations of the controlled-environment facility, the particular good or service is allowed to be provided to the resident. The payments made from the digital wallet associated with the resident may be automatically debited from an appropriate controlled-environment facility resident trust account, controlled-environment facility resident communications account, controlled-environment facility resident commissary account, controlled-environment facility resident media account, (an) other outside account(s), or the like, in the digital wallet associated with the resident. Account management controller 135 may also be configured to charge the resident’s controlled-environment facility resident digital wallet additional fees associated with the transaction. For example, a first fee may be charged on behalf of controlled environment facility 105 and/or a second fee may be charged on its own behalf—i.e., fees due to account management controller 135 for providing digital wallet services.

As noted above, in some cases account management controller 135 may create the controlled-environment facility resident digital wallet in anticipation of a resident’s arrival at facility 105. For example, account management controller 135 may be configured to identify a pool of potential or expected residents (e.g., in the general population or a subset thereof), and, in response to this identification, it may create and/or fund corresponding controlled-environment facility resident digital wallets for each potential or expected resident.

In certain embodiments, when a police officer arrests a suspect, the suspect’s information (e.g., name, date of birth, driver’s license, etc.) may be obtained at or near the point of arrest (e.g., in the police officer’s vehicle, a temporary police station, etc.). In some cases, the officer’s station may be configured to transmit information related to the arrest to a remote location (e.g., facility 105) via network 140, and to advise the proper authorities of the incoming suspect. Thus, in some embodiments, in addition to sending the arrest information through the traditional channels, the arresting officer may also indicate to account management controller 135 that the arrest has been made. Accordingly, account management controller 135 may receive identification information that enables it to activate or open a controlled-environment facility resident digital wallet for the potential or expected resident.

As another example, an alleged criminal may be present in court for a particular hearing (e.g., a sentencing hearing, etc.). The outcome of the hearing may determine whether the alleged criminal will be committed to facility 105. At some point during the course of the proceedings or soon thereafter, relevant information may be entered into the court’s computer system. Accordingly, in some embodiments, account management controller 135 may receive information from the court’s computer system or database indicating that another potential or expected resident will soon be committed to facility 105. Similarly, as explained above, account management controller 135 may activate or open a controlled-environment facility resident digital wallet for another potential or expected resident.

As yet another example, friends and family members 145 (or any other third party such as, for example, legal service provider 125) may provide information to account management controller 135 sufficient for the creation or activation of a controlled-environment facility resident digital wallet for potential or expected resident. Additionally or alternatively, account management controller 135 may maintain or otherwise have access to a database of frequent residents (e.g., a public or proprietary repository of recidivist offenders, etc.) such that it may be capable of creating, maintaining, and/or funding controlled-environment facility resident digital wallets for a person or group of people that are likely to be committed to facility 105 at some point in the future. Furthermore, in some embodiments, account management controller 135 may establish persistent controlled-environment facility resident digital wallets that are maintained between periods of commitment (e.g., incarceration) and/or for longer periods of time (e.g., months or years) for certain residents (e.g., repeat offenders).

As illustrated in FIG. 1, account management controller 135 and controlled environment facility 105 are coupled together via network 140. For example, network 140 may include the Internet, an intranet, a public switched telephone network (PSTN), or any other type of network suitable for allowing communication between two entities. In other embodiments, however, account management controller 135 and controlled environment facility 105 may be directly connected in the absence of network 140 and/or collocated in the same physical area. Similarly, friends and family members 145 may be capable of communicating with account management controller 135 via network 140 (e.g., for requesting that a controlled-environment facility resident digital wallet be opened and/or funded). In alternative embodiments, friends and family members 145 may communicate with account management controller 135 directly and in the absence of network 140 (e.g., by visiting the physical location of account management controller, facility 105, etc.). Although providers 115-130 are illustrated as being configured to communicate and/or transact business with residents 110 through controlled environment facility 105, it should be understood that one or more of providers may interact with residents 110 through network 140. Also, although FIG. 1 illustrates a single controlled environment facility 105, it should be understood that the same account management controller 135 may serve a plurality of controlled environment facilities such as facility 105.

Centralized investigative data aggregation and analysis system 150 may be a platform for providing investigative tools. Such investigative tools may provide collection, processing, analysis, and/or reporting of information for intelligence purposes. In some embodiments, the investigative tools may provide functions such as entity linkage analysis, communication statistics, organization analysis, communication behavior analysis, subscription usage analysis, common communication analysis, timelines, correlations, mapping, word search, language translation (whether machine translation or access to translation services), call recording (whether terminated external to the controlled-environment facility or internally thereto) , call notification, call monitoring (whether real-time or recorded, and whether monitoring a particular call or a plurality of calls), call “barging,” call control, visitation monitoring/background checking, crime tip conduit, account activity monitoring (whether tracing deposits and expenditures of monies or monitoring account trends and behavior, such as velocity of transactions), multiple database querying, and resource integration, and/or the like. One or more of these investigative tools may be provided through an intuitive user interface to provide ease of use, facilitate operations across a variety of user terminals, and/or to facilitate remote access to one or more features thereof. For example, in some cases, a web-based portal enabling individuals to store and transmit information, including forensic tools that analyze communications into and out of controlled-environment facilities to assist law enforcement may be provided. Such a web page portal may have menus comprising an investigator dashboard, to present and facilitate execution of various investigative operations. These investigative tools may log calls (e.g., as CDRs), so that an investigator may research them through an archive and may be provided access to internal and/or external criminal databases and/or other sources of useful information.

In accordance with embodiments of the present systems and methods, centralized investigative data aggregation and analysis system 150, or the like, captures the data associated with the account(s) outside of the controlled-environment facility, the provision of goods or services to the resident, etc. The centralized investigative data aggregation and analysis system then analyzes this captured data associated with the account(s) outside of the controlled-environment facility, the provision of goods or services to the resident and the like for an event of investigative interest (e.g., occurrence of a crime, a violation of controlled-environment facility rules, regulations, policies or procedures, or the like).

FIG. 2 is a block diagram of account management controller 135 according to some embodiments. Particularly, account management engine 210 is configured to request and receive information that allows account management controller 135 to activate, create, fund, and/or maintain controlled-environment facility resident digital wallets 220 for residents 110. In some embodiments, controller 135 may also be configured to manage other types of accounts including, but not limited to, trust accounts 230, calling accounts 240, commissary accounts 250, and/or other accounts 260. Information related to controlled-environment facility maintained controlled-environment facility resident digital wallets 220 (and/or accounts 230-260 (contained therein)) may be stored in controlled-environment facility resident digital wallets database 270. In some embodiments, database 270 may maintain records associating residents 110 with their respective accounts. Database 270 may also include information regarding each account’s balances, previous and pending transactions, subscription fees, reoccurring automatic deposits, etc.

In operation, account management engine 210 may be configured to communicate with payment engine 280 and information exchange and communication module 290. As illustrated, information exchange and communication module 290 may be configured to interact with one or more entities described in connection with FIG. 1. For example, information exchange and communication module 290 may implement communication protocols that allow account management controller 135 to send and/or receive text messages, mobile messages, e-mail, phone calls (e.g., IVR or operator-based), or the like from facility 105, resident(s) 110, friends and family 145, and/or providers 115-130. As such, module 290 may be configured to handle incoming and outgoing messages in various formats. Meanwhile, payment engine 280 may be configured to effect money transfers, fund accounts, clear transactions, etc. in accordance with the operations described below.

In some embodiments, once properly funded (e.g., via deposit, transfer, etc.), a resident’s controlled-environment facility resident digital wallet 220 may be used to directly effect certain transactions. As an example, a transaction may include an attorney consultation or bail bondsmen services. As such, controlled-environment facility resident digital wallet 220 may be used to pay attorney or bail bond fees, automatically from trust account 230, within digital wallet 220. As another example, the transaction may include a commissary purchase, a telephone call, a video visitation, an electronic message, a controlled-environment facility vendor subscription, or the like, and controlled-environment facility resident digital wallet 220 may be used to pay costs associated with those transactions, automatically from respective commissary account 250 or calling account 240, within digital wallet 220. In various embodiments, a resident may be allowed to transfer money from controlled-environment facility resident digital wallet 220 to one or more of accounts 230-260, within digital wallet 220.

As shown in FIG. 2, payment engine 280 may be an integral portion of account management controller 135. In other embodiments, however, payment engine 280 may be external to account management controller 135 and/or controlled or provided by another entity altogether. In those cases, account management engine 210 may be configured to communicate with an external payment engine through module 290. As illustrated, account management controller 135 is configured to create and manage controlled-environment facility resident digital wallet 220, and other entities or parties may maintain their respective accounts. For example, controlled environment facility 105 may maintain trust account 230, commissary distribution company may maintain commissary account 250, phone/video/messaging provider may maintain calling account 240, and so on. In other words, in certain embodiments, account management controller 135 may be directly responsible only for controlled-environment facility resident digital wallets 220. In other embodiments, however, account management controller 135 may be responsible for managing any subset of accounts 230-260. Regardless, embodiments of the present systems and methods combined each of accounts 230 through 260 and/or the like under digital wallet 220, as described herein.

Generally speaking, digital wallet database 270 may include any suitable type of application or data structure that may be configured as a data repository. For example, database 270 may be configured as a relational database that includes one or more tables of columns and rows and that may be searched or queried according to a query language, such as a version of Structured Query Language (SQL). Alternatively, database 270 may be configured as a structured data store that includes data records formatted according to a markup language, such as a version of eXtensible Markup Language (XML). In other embodiments, database 270 may be implemented using one or more arbitrarily or minimally structured data files managed and accessible through any suitable type of application.

Database 270 may generally be configured to store any kind of data related to residents 110, one or more of accounts 230-260, and/or transactions with providers 115-130 in various stages of processing. For example, database 270 may be configured to store information about residents 110, such as names, addresses, prison identification numbers (e.g., associated with a resident’s identification card, radio frequency identification (RFID) bracelets, etc.), driver’s license number, social security numbers, or other information. Database 270 may also be configured to store current and/or historical information regarding transactions with providers 115-130, such as a resident’s order history, payment history, pending transaction requests, or other types of transaction status information.

It is noted that database 270 need not be integrated within account management controller 135. In some embodiments, merchant and/or inventory data may be stored in a number of different and geographically distributed data stores. For example, in some cases, certain transaction data may be stored in a separate database associated and/or controlled by its respective provider(s) (e.g., providers 115-130), and which may be distinct from database 270 of account management controller 135. In other cases, resident identification information may be stored in a separate database associated and/or controlled with controlled environment facility 105, such as a controlled-environment facility Administration and Management System (AMS) database. In a correctional environment such an AMS may be referred to as a Jail Management System (JMS). Accordingly, in some embodiments, information exchange and communication module 290 may be configured to interact with a variety of systems, applications or databases within or external to account management controller 135.

In various embodiments, modules shown in FIG. 2 may represent sets of software routines, logic functions, and/or data structures that are configured to perform specified operations. Although these modules are shown as distinct logical blocks, in other embodiments at least some of the functionality provided by these modules may be combined into fewer blocks. Conversely, any given one of modules 210-290 may be implemented such that its functionality is divided among two or more logical blocks. Moreover, although shown with a particular configuration, in other embodiments these various modules may be rearranged in other suitable ways.

Turning now to FIG. 3, a flowchart of example implementation 300 of controlled-environment facility rules and regulations to provide residents of a controlled-environment facility controlled-environment facility maintained digital wallet, according to some embodiments. Therein, upon implementation of rules and regulations of the controlled-environment facility at 305, a controlled-environment facility account management controller (100), or the like, such as, upon registration, intake booking, or the like, of a resident (inmate) into a controlled-environment facility (correctional facility), creates a digital wallet associated with the resident of the controlled-environment facility, at 310.

At 315, in accordance with the implementation of the controlled-environment facility rules and/or regulations, the controlled-environment facility account management controller, or the like, receives entry of data associated with an account outside the controlled-environment facility from the resident and at 320 inserts, or otherwise places, the outside account data in the digital wallet associated with the resident, as a funding source. This account outside the controlled-environment facility may be a credit card account, a debit card account, a gift card, a checking account, a savings account, an investment account, a retirement account, health savings account, and/or the like. The data associated with an account outside the controlled-environment facility may be entered by, and thereby received from, the resident, at 315, by the resident swiping, or otherwise presenting (e.g., inserting, or presenting for an image/picture capture of) a credit card, debit card, or the like, and/or the resident entering data associated with the credit or debit card (e.g., a PIN, credit or debit card account number, and/or security code), on a keypad provided by a controlled-environment facility kiosk, tablet device, terminal, or the like. Similarly, in accordance with alternative embodiments, entry of data associated with an account outside the controlled-environment facility may be received from a non-resident, with respect to an outside account that belongs to the resident and/or the non-resident.

At 325, the controlled-environment facility account management controller, or the like, creates, or assigns, a controlled-environment facility resident trust account, a controlled-environment facility resident communications account, a controlled-environment facility resident commissary account, a controlled-environment facility resident media account, another outside account, or the like, associated with the resident, in the digital wallet associated with the resident, in accordance with the implementation of the controlled-environment facility rules and/or regulations.

At 330, the controlled-environment facility resident trust account, controlled-environment facility resident communications account, controlled-environment facility resident commissary account, controlled-environment facility resident media account, other outside account, and/or the like, in the digital wallet associated with the resident, is funded by the controlled-environment facility account management controller, or the like, in accordance with the implementation of the controlled-environment facility rules and/or regulations. This funding may be made from the outside account, using the outside account data in the digital wallet associated with the resident. The resident, or a non-resident associated with the funding source, may designate an amount to fund into the one or more controlled-environment facility resident accounts from the outside account. A rebate-type or similar incentive, such as, funding fifty dollars results in a (subsequent) credit or services discount of five dollars, or the like.

Further, in accordance with embodiments of the present systems and methods a determination may be made at 335 as to whether, in accordance with rules and regulations of the controlled-environment facility, a particular good or service ordered by the resident is allowed to be provided to the resident. At 340, payments are made by the controlled-environment facility account management controller, or the like, in accordance with the implementation of the controlled-environment facility rules and/or regulations, for goods and/or services provided to the resident within the controlled-environment facility, such as in response to a determination at 335 that, in accordance with rules and regulations of the controlled-environment facility, the particular good or service is allowed to be provided to the resident. The payments at 340 are made from the digital wallet associated with the resident, such as, by automatically debiting payments from an appropriate one of the controlled-environment facility resident trust account, the controlled-environment facility resident communications account, the controlled-environment facility resident commissary account, the controlled-environment facility resident media account, the other outside account(s), or the like, in the digital wallet associated with the resident. For example, child support, restitution, prison fees, attorney’s fees, bail, etc., or the like, may be paid for out of the resident trust account in the resident’s digital wallet. Phone or video calls, or other electronic communication, or the like, to family, friends, etc., may be paid out of the controlled-environment facility resident communications account in the resident’s digital wallet. The controlled-environment facility resident commissary account in the resident’s digital wallet may be used to pay for personal hygiene items, snacks, or the like. The resident’s digital wallet controlled-environment facility resident media account may be used to pay for music, video or other content for play or streaming on a resident’s controlled-environment facility-adapted, or otherwise approved, media device ( e.g. smartphone, tablet, media player, or the like), including controlled-environment facility vendor-provided subscriptions to such media. At 345 the approved paid-for goods and/or services are provided to the resident in a manner appropriate under the rules and regulations of the controlled-environment facility.

Various implementations of the present systems and methods may employ a debit card or the like to embody the controlled-environment facility resident digital wallet. In such embodiments, a controlled-environment facility service provider, or similar entity may issue the debit card, such as, as a result of a determination by the controlled-environment facility account management controller, or the like, in accordance with the implementation of the rules and regulations of the controlled-environment facility, that the controlled-environment facility service provider should be allowed to issue a debit card to the resident. Access to the digital wallet associated with the resident may be provided to the resident via the issued debit card in such embodiments. Hence, in such embodiments a determination at 335 in accordance with rules and regulations of the controlled-environment facility, is whether a particular good or service the resident is purchasing with the debit card is allowed to be provided to the resident within the controlled-environment facility. Also, in accordance with such embodiments of the present systems and methods, following release of the resident from the controlled-environment facility at 350, payment for goods or services purchased by the resident using the debit card, may be made at 355, irrespective of rules and regulations of the controlled-environment facility.

In accordance with investigative embodiments of the present systems and methods, an investigative data aggregation and analysis system (190), or the like, may, at 360 capture the data associated with the account(s) outside of the controlled-environment facility and the provision of goods or services to the resident, and at 365 analyze captured data associated with these outside account(s) and the provision of goods or services to the resident for an event of investigative interest (e.g., occurrence of a crime, violation of rules and regulations of the controlled-environment facility, or the like). Such analysis may include review of investigative threads, pattern detection, funding within a certain time between two difference inmates, other patterns may over time be identified as helpful to identify potential crimes, etc.

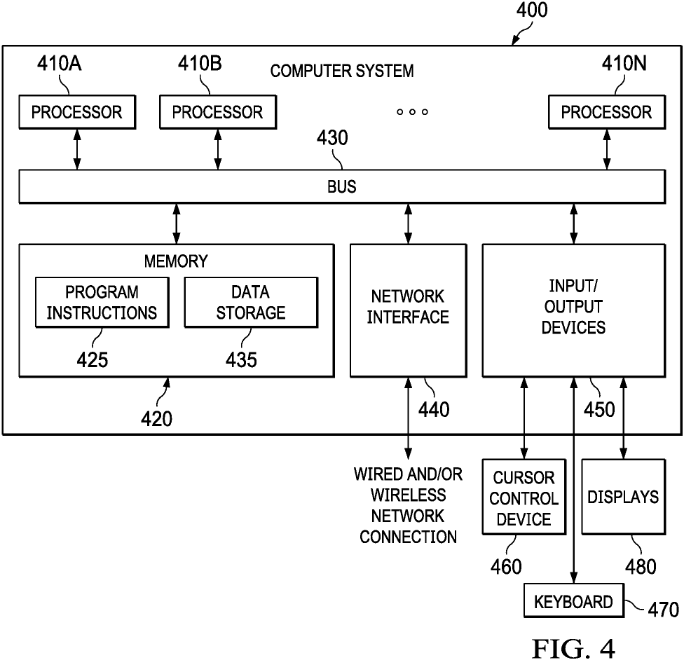

Embodiments of the present systems and methods for providing digital wallets for residents of controlled environment facilities, as described herein, may be implemented at least in part as, or executed, at least in part, by one or more computer systems. One such computer system is illustrated in FIG. 4. In various embodiments, computer system 400 may be a server, a mainframe computer system, a workstation, a network computer, a desktop computer, a laptop, a tablet computing device, media player, or the like. For example, in some cases, computer 400 may implement one or more steps of example process 300 described above with respect to FIG. 3, and/or a computer system such as computer system 400 may be used as part of, one or more of: account management controller 135; the AMS or JMS; non-resident communications devices 145A through C; investigative data aggregation and analysis system 150; controlled-environment facility resident digital wallet management engine 210; controlled-environment facility resident digital wallet database 270; payment engine 280; information exchange and communication module 290; and/or the like. In various embodiments two or more of these computer systems may be configured to communicate with each other in any suitable way, such as, for example, via network 140, which may be the Internet, or the like.

As illustrated, computer system 400 includes one or more processors 410A-N coupled to a system memory 420 via bus 430. Computer system 400 further includes a network interface 440 coupled to bus 430, and one or more I/O controllers 450, which in turn are coupled to peripheral devices such as cursor control device 460, keyboard 470, display(s) 480, etc. Each of I/O devices 460, 470, 480 may be capable of communicating with I/O controllers 450, for example, via a wired connection (e.g., serial port, Universal Serial Bus port) or wireless connection (e.g., Wi-Fi, Bluetooth, Near Field Communications Link, etc.). Other devices may include, for example, microphones, antennas/wireless transducers, phone detection modules, etc.

In various embodiments, computer system 400 may be a single-processor system including one processor 410A, or a multi-processor system including two or more processors 410A-N (e.g., two, four, eight, or another suitable number). Processors 410 may be any processor capable of executing program instructions. For example, in various embodiments, processors 410 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 410 may commonly, but not necessarily, implement the same ISA. Also, in some embodiments, at least one processor 410 may be a graphics processing unit (GPU) or another dedicated graphics-rendering device.

System memory 420 may be configured to store program instructions and/or data accessible by processor 410. In various embodiments, system memory 420 may be implemented using any suitable memory technology, such as static random-access memory (SRAM), synchronous dynamic RAM (SDRAM), nonvolatile/Flash-type memory, or any other type of memory. As illustrated, program instructions and data implementing certain operations and modules such as those described herein may be stored within system memory 420 as program instructions 425 and data storage 435, respectively. In other embodiments, program instructions and/or data may be received, sent, or stored upon different types of computer-accessible media or on similar media separate from system memory 420 or computer system 400.

A computer-accessible medium may include any tangible and/or non-transitory storage media or memory media such as electronic, magnetic, or optical media-e.g., disk or CD/DVD-ROM coupled to computer system 400 via bus 430. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 430 may be configured to coordinate I/O traffic between processor 410, system memory 420, and any peripheral devices in the computer system, including network interface 440 or other peripheral interfaces, such as I/O devices 460, 470, 480. In some embodiments, bus 430 may perform any necessary protocol, timing, or other data transformations to convert data signals from one component (e.g., system memory 420) into a format suitable for use by another component (e.g., processor 410). In some embodiments, bus 430 may include support for devices attached through various types of peripheral buses, such as a variant of the Peripheral Component Interconnect (PCI) bus standard or the Universal Serial Bus (USB) standard, for example. In some embodiments, the function of bus 430 may be split into two or more separate components, such as a northbridge chipset and a southbridge chipset, for example. In addition, in some embodiments some or all the functionality of bus 430, such as an interface to system memory 420, may be incorporated directly into processor(s) 410A-N.

Network interface 440 may be configured to allow data to be exchanged between computer system 400 and other devices attached to a network, such as other computer systems, or between nodes of computer system 400. In various embodiments, network interface 440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

I/O controllers 450 may, in some embodiments, enable communications with one or more display terminals, keyboards, keypads, touchpads, scanning devices, voice or optical recognition devices, mobile devices, or any other devices suitable for entering or retrieving data by one or more computer system 400. Multiple I/O controllers 450 may be present in computer system 400 or may be distributed on various nodes of computer system 400. In some embodiments, I/O devices may be separate from computer system 400 and may interact with one or more nodes of computer system 400 through a wired or wireless connection, such as over network interface 440.

As shown in FIG. 4, system memory 420 may include program instructions 425, configured to implement certain embodiments described herein, and data storage 435, comprising various data may be accessible by program instructions 425. In an embodiment, program instructions 425 may include software elements, which may be configured to affect the operations discussed in FIGS. 1 through 3. Program instructions 425 may be implemented in various embodiments using any desired programming language, scripting language, or combination of programming languages and/or scripting languages (e.g., C, C++, C#, JAVA®, JAVASCRIPT®, PERL®, etc.). Data storage 435 may include data that may be used in these embodiments (e.g., recorded communications, profiles for different modes of operations, etc.). In other embodiments, other or different software elements and data may be included.

A person of ordinary skill in the art will appreciate that computer system 400 is merely illustrative and is not intended to limit the scope of the disclosure described herein. The computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

The various operations described herein, particularly in connection with FIGS. 1 through 3, may be implemented in software executed by processing circuitry, hardware, or a combination thereof. The order in which each operation of a given method is performed may be changed, and various operations may be added, reordered, combined, omitted, modified, etc. It is intended that embodiment(s) described herein embrace all such modifications and changes and, accordingly, the above description should be regarded in an illustrative rather than a restrictive sense.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An inmate digital wallet system comprising:
a correctional facility account management controller comprising at least one processor, and a memory coupled to the at least one processor, the memory configured to store program instructions executable by the at least one processor to cause the correctional facility account management controller to:
implement rules and regulations of a correctional facility;
create a digital wallet associated with an inmate of the correctional facility, in accordance with the implementation of the rules and regulations of the correctional facility;
receive account identifying data associated with an account outside the correctional facility, entered by the inmate swiping, or presenting for image capture, a credit card or debit card and/or entering account identifying data associated with the credit card or debit card on a keypad provided by a correctional facility kiosk, tablet device or terminal, in accordance with the implementation of the rules and regulations of the correctional facility;
insert the outside account identifying data in the digital wallet associated with the inmate as a funding source under the rules and regulations of the correctional facility;
create or assign, in accordance with the implementation of the rules and regulations of the correctional facility, at least two of an inmate trust account, an inmate communications account, an inmate commissary account and an inmate media account, associated with the inmate, in the digital wallet associated with the inmate;
fund, in accordance with the implementation of the rules and regulations of the correctional facility, at least two of the inmate trust account, inmate communications account, inmate commissary account and inmate media account in the digital wallet associated with the inmate, from the outside account, using the outside account identifying data in the digital wallet associated with the inmate; and
make payments for goods or services provided to the inmate in accordance with the implementation of the rules and regulations of the correctional facility, from the digital wallet associated with the inmate by automatically debiting payments from an appropriate one or more of the inmate trust account, inmate communications account, inmate commissary account and inmate media account in the digital wallet associated with the inmate.

2. The system of claim 1, wherein the program instructions, upon execution by the at least one processor, further cause the correctional facility account management controller to:
determine whether, in accordance with the rules and regulations of the correctional facility, whether a particular good or service is allowed to be provided to the inmate; and
provide the particular good or service to the inmate, and make the payment for provision of the particular good or service from the digital wallet associated with the inmate in response to a determination that in accordance with the implementation of rules and regulations of the correctional facility, the particular good or service is allowed to be provided to the inmate.

3. The system of claim 1, wherein the program instructions, upon execution by the at least one processor, further cause the correctional facility account management controller to, in accordance with the implementation of the rules and regulations of the correctional facility, create the digital wallet associated with the inmate upon intake of the inmate into the correctional facility.

4-5. (canceled)

6. The system of claim 1, wherein the program instructions, upon execution by the at least one processor, further cause the correctional facility account management controller to:
determine, in accordance with the implementation of the rules and regulations of the correctional facility whether a correctional facility service provider should be allowed to issue an outside debit card to the inmate; and
provide access to the digital wallet associated with the inmate, in accordance with the implementation of the rules and regulations of the correctional facility, via the outside debit card.

7. The system of claim 6 wherein the program instructions, upon execution by the at least one processor, further cause the correctional facility account management controller to:
determine whether, in accordance with the implementation of the rules and regulations of the correctional facility, whether a particular good or service the inmate is purchasing with the outside debit card is allowed to be provided to the inmate within the correctional facility; and
provide the particular good or service to the inmate, and make the payment for provision of the particular good or service from the digital wallet associated with the inmate, in response to a determination that in accordance with the implementation of the rules and regulations of the correctional facility, the particular good or service is allowed to be provided to the inmate, by automatically debiting payments from an appropriate one or more of the inmate trust account, inmate communications account, inmate commissary account and inmate media account in the digital wallet associated with the inmate.

8. The system of claim 6, wherein the program instructions, upon execution by the at least one processor, further cause the correctional facility account management controller to, following release of the inmate from the correctional facility, cease implementation of the rules and regulations of a correctional facility and make payment for goods or services purchased by the inmate using the outside debit card, irrespective of rules and regulations of the correctional facility.

9. The system of claim 1, wherein the account outside the correctional facility is at least one of a credit card account, a debit card account, a gift card, a checking account, a savings account, an investment account, a retirement account, or a health savings account.

10. The system of 1, wherein the program instructions, upon execution by the at least one processor, further cause the correctional facility account management controller to, in accordance with the implementation of the rules and regulations of the correctional facility, receive entry of data associated with, or create in, or assign to, the digital wallet associated with the inmate, at least one other account outside the correctional facility.

11. The system of claim 10, wherein the program instructions, upon execution by the at least one processor, further cause the correctional facility account management controller to, in accordance with the implementation of the rules and regulations of the correctional facility:
fund the at least one other account outside the correctional facility in the digital wallet associated with the inmate from the outside account using the outside account identifying data in the digital wallet associated with the inmate; and/or
make payments for provision of goods or services to the inmate within the correctional facility, from the digital wallet associated with the inmate by automatically debiting payments from an appropriate one or more of the at least one other account outside the correctional facility, the inmate trust account, the inmate communications account, the inmate commissary account and the inmate media account in the digital wallet associated with the inmate.

12. The system of claim 1, further comprising an investigative data aggregation and analysis system comprising at least one further processor, and a further memory coupled to the at least one further processor, the further memory configured to store program instructions executable by the at least one further processor to cause the investigative data aggregation and analysis system to:
capture the data associated with the account outside of the correctional facility and the provision of goods or services to the inmate within the correctional facility; and
analyze captured data associated with the account outside of the correctional facility and the provision of goods or services to the inmate within the correctional facility for an event of investigative interest.

13. A method for providing inmates of a correctional facility digital wallets comprising:
creating, by a correctional facility account management controller, a digital wallet associated with an inmate of a correctional facility;
receiving, by the correctional facility account management controller, entry of account identifying data associated with an account outside the correctional facility by the inmate swiping, or presenting for image capture, a credit card or a debit card and/or entering account identifying data associated with the credit card or the debit card on a keypad provided by a correctional facility kiosk, tablet device or terminal;
inserting, by the correctional facility account management controller, the outside account identifying data in the digital wallet associated with the inmate as a funding source;
creating, or assigning, by the correctional facility account management controller, at least two of an inmate trust account, an inmate communications account, an inmate commissary account and an inmate media account, associated with the inmate, in the digital wallet associated with the inmate;
funding at least two of the inmate trust account, inmate communications account, inmate commissary account and inmate media account in the digital wallet associated with the inmate, by the correctional facility account management controller, from the outside account, using the outside account identifying data in the digital wallet associated with the inmate; and
making payments, by the correctional facility account management controller, for provision of goods or services to the inmate within the correctional facility, from the digital wallet associated with the inmate by automatically debiting payments from an appropriate one or more of the inmate trust account, inmate communications account, inmate commissary account and inmate media account in the digital wallet associated with the inmate.

14. The method of claim 13, wherein the digital wallet associated with the inmate is created upon intake of the inmate into the correctional facility.

15-16. (canceled)

17. The method of claim 13, further comprising:
determining whether, in accordance with rules and regulations of the correctional facility, a particular good or service is allowed to be provided to the inmate; and
providing the particular good or service to the inmate, and making the payment for provision of the particular good or service from the digital wallet associated with the inmate in response to a determination that in accordance with rules and regulations of the correctional facility, the particular good or service is allowed to be provided to the inmate.

18. The method of claim 13 further comprising:
issuing by a correctional facility service provider an outside debit card; and
providing access to the digital wallet associated with the inmate via the outside debit card.

19. The method of claim 18 further comprising:
determining whether, in accordance with rules and regulations of the correctional facility whether a particular good or service the inmate is purchasing with the outside debit card is allowed to be provided to the inmate within the correctional facility; and
providing the particular good or service to the inmate, and making the payment for provision of the particular good or service from the digital wallet associated with the inmate, in response to a determination that in accordance with rules and regulations of the correctional facility, the particular good or service is allowed to be provided to the inmate within the correctional facility, by automatically debiting payments from an appropriate one or more of the inmate trust account, inmate communications account, inmate commissary account and inmate media account in the digital wallet associated with the inmate.

20. The method of claim 18 further comprising, following release of the inmate from the correctional facility, making payment for goods or services purchased by the inmate using the outside debit card, irrespective of rules and regulations of the correctional facility.

21. The method of claim 13, wherein the account outside the correctional facility is at least of a credit card account, a debit card account, a gift card, a checking account, a savings account, an investment account, a retirement account, or a health savings account.

22. The method of claim 13, further comprising receiving entry of account identifying data associated with, or creating in, or assigning to, the digital wallet associated with the inmate, at least one other account outside the correctional facility.

23. The method of claim 22, further comprising funding the at least one other account outside the correctional facility in the digital wallet associated with the inmate from the outside account using the outside account data in the digital wallet associated with the inmate; and/or
making payments for provision of goods or services to the inmate within the correctional facility, from the digital wallet associated with the inmate by automatically debiting payments from an appropriate one or more of the at least one other account outside the correctional facility, the inmate trust account, the inmate communications account, the inmate commissary account and the inmate media account in the digital wallet associated with the inmate.

24. The method of claim 13, further comprising:
capturing, by an investigative data aggregation and analysis system, the data associated with the account outside of the correctional facility and the provision of goods or services to the inmate within the correctional facility; and
analyzing captured data associated with the account outside of the correctional facility and the provision of goods or services to the inmate within the correctional facility for an event of investigative interest.

25. A non-transitory computer-readable storage medium having program instructions stored thereon that, upon execution by a correctional facility account management controller, cause the correctional facility account management controller to:
implement rules and regulations of a correctional facility;
create a digital wallet associated with an inmate of the correctional facility, in accordance with the implementation of the rules and regulations of the correctional facility;
receive, in accordance with the implementation of the rules and regulations of the correctional facility, account identifying data associated with an account outside the correctional facility, entered by the inmate swiping, or presenting for image capture, a credit card or a debit card and/or entering account identifying data associated with the credit card or the debit card on a keypad provided by a correctional facility kiosk, tablet device or terminal;
insert the outside account identifying data in the digital wallet associated with the inmate as a funding source under the rules and regulations of the correctional facility;
create or assign, in accordance with the implementation of the rules and regulations of the correctional facility, at least two of an inmate trust account, an inmate communications account, an inmate commissary account and an inmate media account, associated with the inmate, in the digital wallet associated with the inmate;
fund, in accordance with the implementation of the rules and regulations of the correctional facility, at least two of the inmate trust account, inmate communications account, inmate commissary account and inmate media account in the digital wallet associated with the inmate, from the outside account, using the outside account identifying data in the digital wallet associated with the inmate; and
make payments for goods or services provided to the inmate in accordance with the implementation of the rules and regulations of the correctional facility, from the digital wallet associated with the inmate by automatically debiting payments from an appropriate one or more of the inmate trust account, inmate communications account, inmate commissary account and inmate media account in the digital wallet associated with the inmate.
